(19) United States
(12) Patent Application Publication
(10) Pub. No.: US 2019/0027147 A1
(43) Pub. Date: Jan. 24, 2019

(54) AUTOMATIC INTEGRATION OF IMAGE CAPTURE AND RECOGNITION IN A VOICE-BASED QUERY TO UNDERSTAND INTENT

(71) Applicant: Microsoft Technology Licensing, LLC, Redmond, WA (US)

(72) Inventors: Adi Diamant, Shoham (IL); Karen Master Ben-Dor, Kfar Saba (IL)

(73) Assignee: Microsoft Technology Licensing, LLC, Redmond, WA (US)

(21) Appl. No.: 15/652,498

(22) Filed: Jul. 18, 2017

(51) Int. Cl. G10L 15/24; G06K 9/00; G10L 15/26; G10L 15/22; G06K 9/32; G06F 17/30

(52) U.S. Cl. CPC G10L 15/24; G06K 9/00624; G10L 15/265; G10L 2015/223; G06K 9/3258; G06F 17/30265; G10L 15/22

(57) ABSTRACT

Query understanding using integrated image capture and recognition is provided. A user is enabled to speak an utterance which is received by a digital assistant executing on a computing device. The utterance includes a spoken trigger, which is detected by the digital assistant and activates a camera integrated in or communicatively attached to the computing device. The camera captures an image of an object or person of interest. The utterance, the image, and temporally relevant context information are provided to an image integrated query system, which performs speech recognition and image processing on the utterance and the image for understanding the user intent. The understood intent is provided to the digital assistant, which operates to complete perform a search query or complete a task indicated in the integrated utterance and image data.

### BACKGROUND

Machine learning, language understanding, and artificial intelligence are changing the way users interact with computers. For example, as natural and intelligent user interface technology is being integrated into computing devices, many users are increasingly interacting with their computing devices in a natural, conversational way. One challenge that this presents is that human speech is not always precise; oftentimes it is ambiguous and can depend on a variety of variables (e.g., contextual information) to understand not only whether the user is talking to the device to start with, but also to understand what a user is saying and also the user's intent.

### SUMMARY

This summary is provided to introduce a selection of concepts in a simplified form that are further described below in the Detailed Description section. This summary is not intended to identify all features of the claimed subject matter, nor is it intended as limiting the scope of the claimed subject matter.

Aspects are directed to a system, method, and computer readable storage device for providing query understanding using integrated image capture and recognition combined with a speech based query. When using a digital assistant executing on a computing device, a user is enabled to speak an utterance which is received by the digital assistant. For example, the utterance can be a search query or a command to perform a task or provide a service. According to an aspect, the utterance includes a spoken trigger term or an implied trigger. Responsive to receiving an indication of a trigger, a camera integrated in or communicatively attached to the computing device is activated and captures an image. For example, the user may hold an object of interest up to the camera or point the camera at an object of interest. The utterance, the image, and temporally relevant context information are provided to an image integrated query system, which performs speech recognition and image processing on the utterance and the image for understanding the user intent. That is, natural language based clues are used to understand that the user intent may be related to an object in the camera frame. The understood intent is provided to the digital assistant, which operates to complete perform a search query or complete a task indicated in the integrated utterance and image data.

Disclosed aspects enable the benefit of technical effects that that include, but are not limited to, shortening the cycle for user intent understanding and task completion by artificial intelligence-based assistance; an improved user experience in a successful seamless/automatic integration of an image search in a search query or command; and improved user efficiency and increased user interaction performance by automatically acquiring context for a search query or command for understanding user intent for task completion responsive to a detection of a trigger.

The details of one or more aspects are set forth in the accompanying drawings and description below. Other features and advantages will be apparent from a reading of the following detailed description and a review of the associated drawings. It is to be understood that the following detailed description is explanatory only and is not restrictive; the proper scope of the present disclosure is set by the claims.

### BRIEF DESCRIPTION OF THE DRAWINGS

The accompanying drawings, which are incorporated in and constitute a part of this disclosure, illustrate various aspects of the present disclosure. In the drawings:

FIG. 1A is a block diagram illustrating an example contextual language understanding system implemented at a client computing device for providing query understanding using integrated image capture and recognition according to one aspect;

FIG. 1B is a block diagram illustrating an example contextual language understanding system implemented at a server computing device for providing query understanding using integrated image capture and recognition according to another aspect;

FIGS. 2A-F show an illustrative scenario where a user provides a trigger in an utterance, and an image is automatically captured and processed as contextual information in query understanding and task completion;

FIGS. 3A-D show another illustrative scenario where a user provides a trigger in an utterance, and an image is automatically captured and processed as contextual information in query understanding and task completion;

FIG. 4 is a flowchart showing general stages involved in an example method for providing query understanding using integrated image capture and recognition;

FIG. 5 is a block diagram illustrating physical components of a computing device with which examples may be practiced;

FIGS. 6A and 6B are block diagrams of a mobile computing device with which aspects may be practiced; and

FIG. 7 is a block diagram of a distributed computing system in which aspects may be practiced.

### DETAILED DESCRIPTION

The following detailed description refers to the accompanying drawings. Wherever possible, the same reference numbers are used in the drawings and the following description to refer to the same or similar elements. While aspects of the present disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the present disclosure, but instead, the proper scope of the present disclosure is defined by the appended claims. Examples may take the form of a hardware implementation, or an entirely software implementation, or an implementation combining software and hardware aspects. The following detailed description is, therefore, not to be taken in a limiting sense.

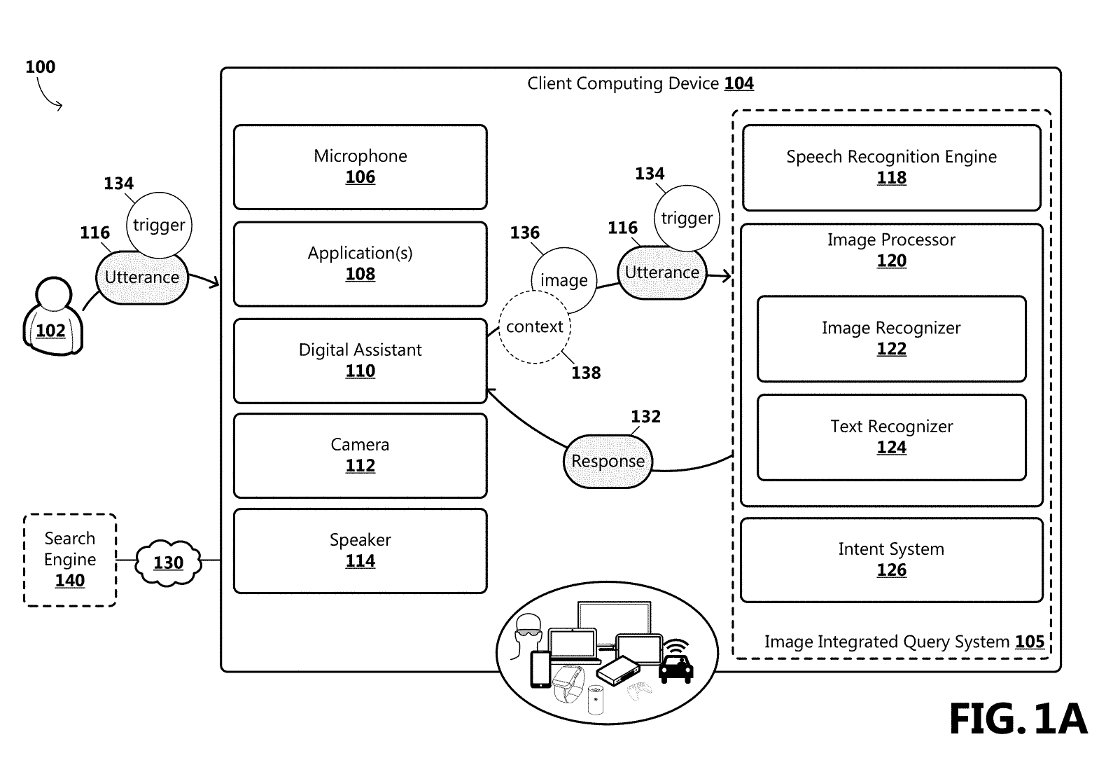

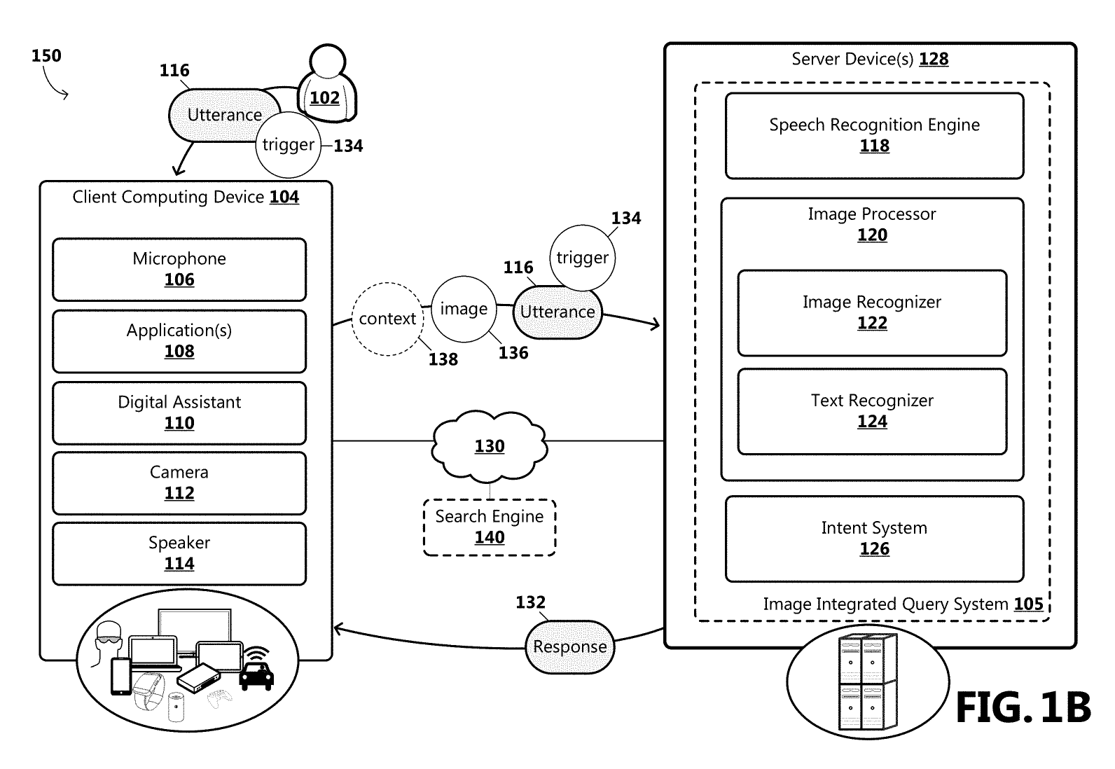

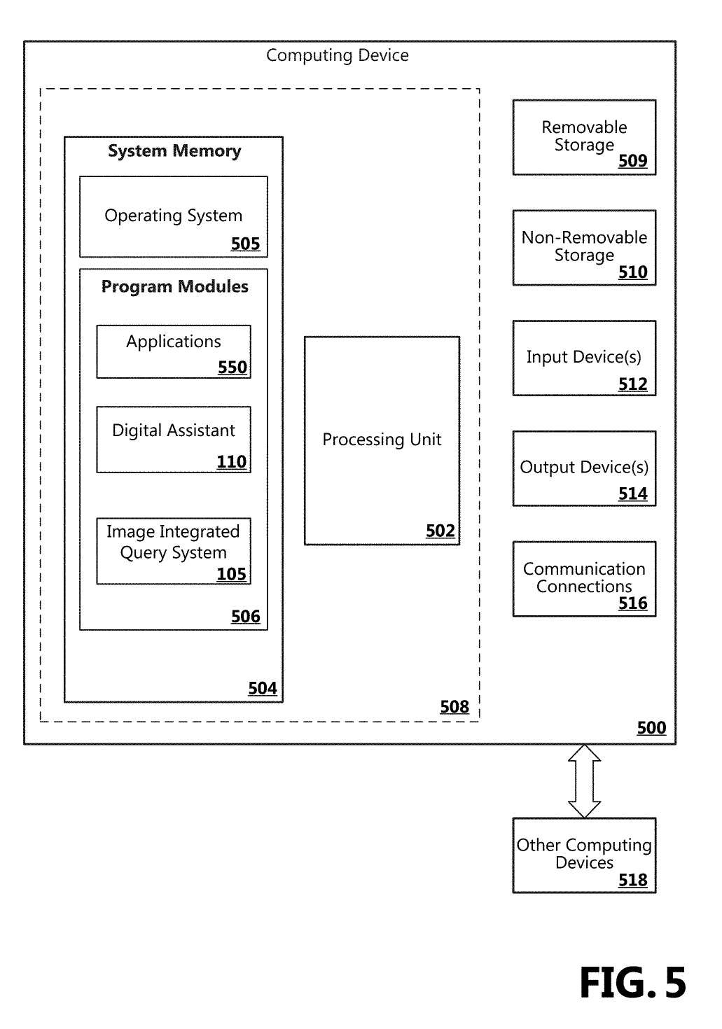

Aspects of the present disclosure are directed to a system, method, and computer readable storage device for providing query understanding using integrated image capture and recognition. FIGS. 1A and 1B illustrate example computing environments 100,150 in which an image integrated query system 105 can be implemented for integration of an image search and relevant context information, for example, to understand a speech-based query based in part on recognition of an image automatically captured responsive to a trigger input, according to various aspects. In some examples and as shown in FIG. 1A, the image integrated query system 105 is implemented on a client computing device 104. The client computing device 104 can be one of various types of computing devices (e.g., a tablet computing device, a desktop computer, a mobile communication device, a laptop computer, a laptop/tablet hybrid computing device, a large screen multi-touch display, a gaming device, a smart television, a wearable device, a connected automobile, a smart home device, IoT (Internet of Things) or dedicated device with or without a display, or other type of computing device) for implementing the image integrated query system 105 for providing query understanding using integrated image capture and recognition. In other examples and as illustrated in FIG. 1B, the image integrated query system 105 is implemented on one or a plurality of server computing devices 128, as illustrated in FIG. 1B. The server computing device 128 is operative to provide data to and receive data from the client computing device 104 through a network 130 or a plurality of networks. In some examples, the network 130 is a distributed computing network, such as the Internet. In some examples, the image integrated query system 105 is a hybrid system that includes the client computing device 104 as illustrated in FIG. 1A in conjunction with the server computing device 128 as illustrated in FIG. 1B. The hardware of these computing devices is discussed in greater detail in regard to FIGS. 5, 6A, 6B, and 7.

As illustrated, the client computing device 104 includes a digital assistant 110. Digital assistant functionality can be provided as or by a stand-alone application, part of an application 108, or part of an operating system of the client computing device 104. According to an aspect, the digital assistant 110 employs a natural language user interface (UI) that can receive spoken utterances 116 (e.g., voice control, commands, queries, prompts) from a user 102 that are processed with voice or speech recognition technology. For example, the natural language UI can include a microphone 106. That is, the client computing device 104 comprises a microphone 106 that can be an internal or integral part of the client computing device, or can be an external source (e.g., USB microphone or the like). Further, the client computing device 104 can include a speaker 114 and a plurality of other hardware sensors. The digital assistant 110 can support various functions, which can include interacting with the user 102 (e.g., through the natural language UI and other graphical UIs); performing tasks (e.g., making note of appointments in the user's calendar, sending messages and emails); providing services (e.g., answering questions from the user, mapping directions to a destination); gathering information (e.g., finding information requested by the user about a book or movie, locating the nearest Italian restaurant); operating the client computing device 104 (e.g., setting preferences, adjusting screen brightness, turning wireless connections on and off); and various other functions. The functions listed above are not intended to be exhaustive and other functions may be provided by the digital assistant 110. In some examples, the digital assistant 110 is a personal digital assistant. In other examples, the digital assistant 110 is a general digital assistant, such as a customer support digital agent that provides assistance to a plurality of users 102.

The microphone 106 functions to capture audio input, such as spoken utterances 116 from the user 102. The spoken utterances 116 can be used to invoke various actions, features, and functions on the client computing device 104, provide inputs to systems and applications 108, and the like. In some cases, the spoken utterances 116 can be used on their own in support of a particular user experience, while in other cases the spoken utterances can be used in combination with other non-voice commands or inputs, such as inputs implementing physical controls on the device or virtual controls implemented on a UI or as inputs using gestures.

According to an aspect, the digital assistant 110 is operative to pass a received utterance 116 to the image integrated query system 105, which includes a speech recognition engine 118, an image processor 120, and an intent system 126. In some examples, the speech recognition engine 118, the image processor 120, and the intent system 126 are implemented and executed on the client computing device 104. In other examples, the speech recognition engine 118, the image processor 120, and the intent system 126 are implemented and executed on a server computing device 128. In other examples, one or more of the speech recognition engine 118, the image processor 120, and the intent system 126 are distributed across a plurality of server computing devices 128. In other examples, one or more of the speech recognition engine 118, the image processor 120, and the intent system 126 are distributed across the client computing device 104 and one or more server computing devices 128.

The speech recognition engine 118 is illustrative of a software module, system, or device that is operative to receive utterances 116 from the digital assistant 110, and to perform speech recognition on the utterances for converting the spoken audio to text. According to an aspect, the utterance 116 includes a search query or a command. In some examples, the speech recognition engine 118 is exposed to the digital assistant 110 as an API (Application Programming Interface). In various examples, the speech recognition engine 118 includes an acoustic model and a language model. The acoustic model is created by taking audio recordings of speech and their transcriptions and then compiling them into statistical representations of the sounds for words. The language model gives the probabilities of sequences of words. According to an aspect, the speech recognition engine 118 is further operative to pass the translated text to the intent system 126.

According to an aspect, a spoken utterance 116 received by the digital assistant 110 can include a trigger 134 corresponding to activation of a camera 112 integrated in or communicatively attached to the client computing device 104. The voice or speech recognition technology, which can be integrated with the digital assistant or the client computing device 104, performs voice or speech recognition on the received utterance 116, and is operative to recognize or detect the trigger 134 in the utterance. The trigger 134 is a word or phrase that operates as a signal to initiate an image capture command. In some examples, the trigger is a preconfigured term or phrase. In other examples, the trigger is a term or phrase that is set by the user 102. Further, the trigger 134 can be configured to be a plurality of terms or phrases. The trigger term 134 can be an arbitrary term or phrase (e.g., “shazam”, “take pic”), or can be an indefinite pronoun or other type of term or phrase referring to an entity (e.g., an object or being) that is not specified in a current utterance 116, but is an object or being in the user's environment. In some examples, the trigger 134 includes one or more literal trigger terms, such as “this”, “that”, “those”, “it”, “these”, “him”, “her”, “them”, “us”, and the like. In other examples, the trigger 134 includes an implied trigger. For example, consider that a user 102 points a camera-enabled computing device 104 at a particular car and speaks the utterance “Ayeye, what is the average gas mileage.” In this example, the trigger 134 is an identification of the phrase (e.g., “what is the average gas mileage”) determined to be a signal to initiate the image capture command. In one example, the determination that a word or phrase is a signal to initiate the image capture command is based on whether an utterance 116 is ambiguous without additional context information 138.

Consider for example that a user 102 speaks the following utterance 116: “Hey, Ayeye. What is this?” In this example, the trigger 134 is the word “this”. The trigger “this” is just one example. Many other terms, phrases, or implied triggers can be used as triggers 134 as described above. The digital assistant 110 receives the utterance 116 (via the microphone 106). In some examples, the utterance 116 is received in response to activation of the digital assistant 110. For example, the client computing device 104 can use a trigger word or phrase (distinct from the trigger 134) to launch the digital assistant 110. In the above example, the trigger word or phrase that launches the digital assistant 110 is “Hey, Ayeye”. The trigger word or phrase “Hey, Ayeye” is just one example.

Upon recognition of “this” (trigger 134), the digital assistant 110 is operative to determine that the received trigger 134 is associated with an image capture command. Upon receiving an indication of the trigger 134 and an initiation of the image capture command, the digital assistant 110 is operative to invoke a camera 112 integrated in or communicatively attached to the client computing device 104. According to an aspect, the camera 112 automatically turns on, and an image 136 seen through the lens of the camera is captured. Consider for example that the user 102 is using a mobile phone (client computing device 104). The user can point the phone at an object of interest, such as a carton of milk, and speak an utterance, such as: “add this to my shopping cart.” Accordingly, the digital assistant 110 identifies the trigger 134 “this”, and automatically turns on the camera 112 and captures an image of the object of interest (e.g., the milk carton). Some exemplary utterances 116 that can include a search query or a command and a literal or implied trigger 134 are: “what is this,” “play this music,” “play music by this band,” “tell me about this,” “what can I cook with this,” “who is this person,” “where can I buy this,” “buy a ticket to this,” “set a meeting with him/her,” “where can I find this,” “how do I fix this,” “where can I return this,” “purchase,” “it's the wrong size; where can I replace it,” etc.

In some examples, the client computing device 104 includes more than one camera 112. For example, the client computing device 104 can be embodied as a mobile computing device (e.g., phone, tablet) that includes a front-facing camera and a rear-facing camera. According to one example, when a client computing device 104 comprises more than one camera 112, a determination is made as to which camera is relevant for the given interaction, which can be based on the type of client computing device 104 being used. For example, when using a mobile phone or a tablet device that is not connected to a keyboard, the rear-facing camera is activated. As another example, when using a tablet device that is connected to a keyboard, the front-facing camera is activated. In some examples, the image 136 captured by the camera 112 is displayed in the GUI.

According to an aspect, the digital assistant 110 is further operative to pass the captured image 136 to the image integrated query system 105, where the image processor 120 operates to analyze the image and identify objects, places, people, writing, or actions in the image. In some examples, the image 136 is passed to the image integrated query system 105 upon receiving a selection, such as a spoken command, or a gesture from the user 102. In some examples, the image processor 120 is exposed to the digital assistant 110 as an API. According to an aspect, the image processor 120 uses deep learning-based image recognition. For example, the image processor 120 can include machine learning models: an image recognizer 122 that classifies an image 136 into a plurality of categories (e.g., “sailboat”, “lion”, “Eiffel Tower”) and detects individual objects and faces within the image, and a text recognizer 124 that finds and reads text included within the image. For example, the text recognizer 124 is operative to detect regions in an image 136 that contain typed, handwritten or printed text, and apply text recognition, such as optical character recognition (OCR), to recognize and extract the text, and convert the text into a machine readable text format. In some examples, the image processor 120 is operative to integrate with a search engine 140 to find related entities and similar images from the web. The image processor 120 is further operative to pass recognized objects and text to the intent system 126.

The intent system 126 is operative to receive the text translated from the received utterance 116 and the objects and text recognized from the captured image 136, and interpret the content of the image as part of the search query or command indicated in the utterance. According to one aspect, the intent system 126 recognizes and replaces the trigger 134 in the text translated from the received utterance 116 with the identified object(s) and text from the captured image 136. The intent system 126 is further operative to perform intent understanding for identifying an action the user 102 wants the client computing device 104 to take or information the user would like to obtain, conveyed in the spoken utterance 116. According to an example, the intent system 126 is exposed as an API.

In some examples, the digital assistant 110 provides context information 138 to the image integrated query system 105. Context data 138 can include, for example, time/date, the user's location, language, schedule, applications 108 installed on the client computing device 104, the user's preferences, the user's behaviors (in which such behaviors are monitored/tracked with notice to the user and the user's consent), stored contacts (including, in some cases, links to a local user's or remote user's social graph such as those maintained by external social networking services), call history, messaging history, browsing history, device type, device capabilities, and the like. According to an aspect, the intent system 126 applies context data 138 that is available to it to enable interactions with the user 102 that are more natural and an overall user experience supported by the digital assistant 110 that is enhanced. That is, the intent system 126 is operative to apply context data 138 provided to it by the digital assistant 110 to the combined text translated from the received utterance 116 and the objects and the text recognized from the captured image 136 for understanding the semantic intent of the search query or command indicated in the utterance 116. According to examples, the intent system 126 uses natural language processing to process the combined text translated from the received utterance 116 and the objects and the text recognized from the captured image 136 in association with available context information 138.

According to an example, the intent is determined to be a search query. In some examples, the image integrated query system 105 queries a search engine 140 based on the semantic intent and context information 138. For example, a semantic search identifies the intent and the context, and provides relevant results based on that knowledge. Accordingly, the image integrated query system 105 is operative to provide a response 132 based on a highest ranked result to the digital assistant 110. In other examples, the image integrated query system 105 provides the combined text translated from the received utterance 116 and the objects and the text recognized from the captured image 136 and the understood semantic intent of the search query or command indicated in the utterance 116 to the digital assistant 110 in a response 132. For example, the digital assistant 110 can query a search engine 140 based on the semantic intent and context information 138. According to another example, the intent is determined to be a task to be performed or a service to be provided. Upon determining the intent, the image integrated query system 105 passes the task or service request to the digital assistant in a response 132. For example, the digital assistant 110 is operative to execute the command (e.g., perform the task or provide the service) indicated in the utterance 116.

Continuing the example from above where the user 102 points a phone at the carton of milk and speaks the utterance “add this to my shopping cart,” upon understanding the semantic intent, the digital assistant 110 can activate a shopping application 108 on the client computing device 104, search for the identified object of interest (milk), and then place the object of interest in a shopping cart. In some examples, the combined text translated from the received utterance 116 and the objects and the text recognized from the captured image 136 are determined to be ambiguous based on a confidence level.

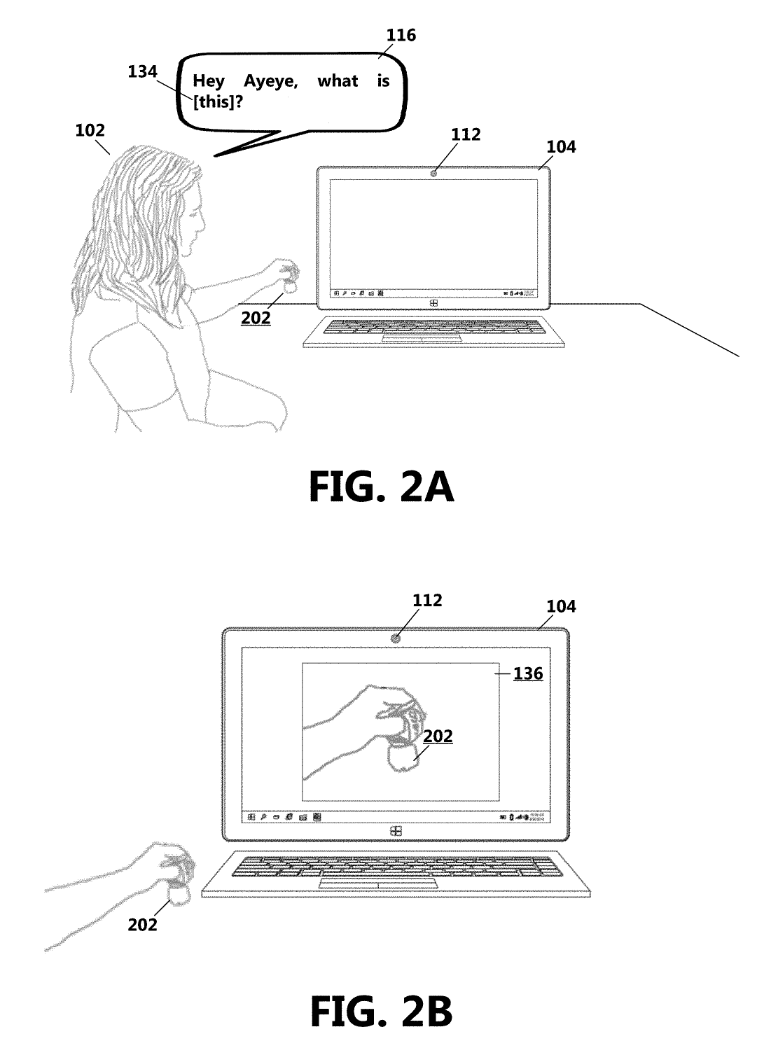

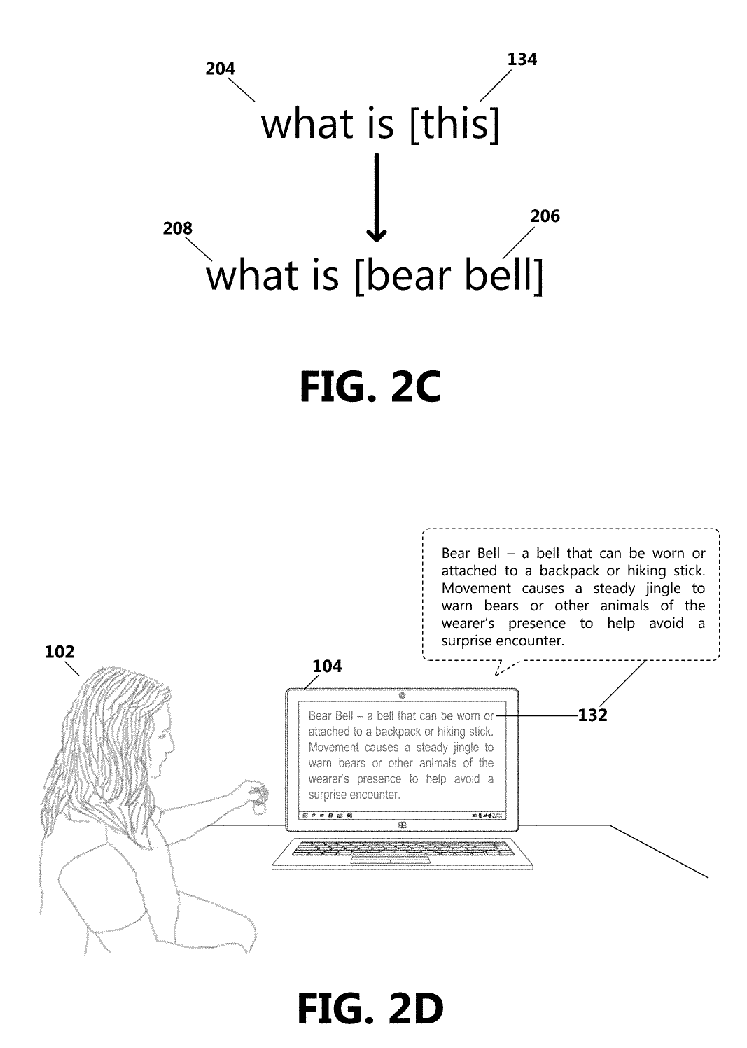

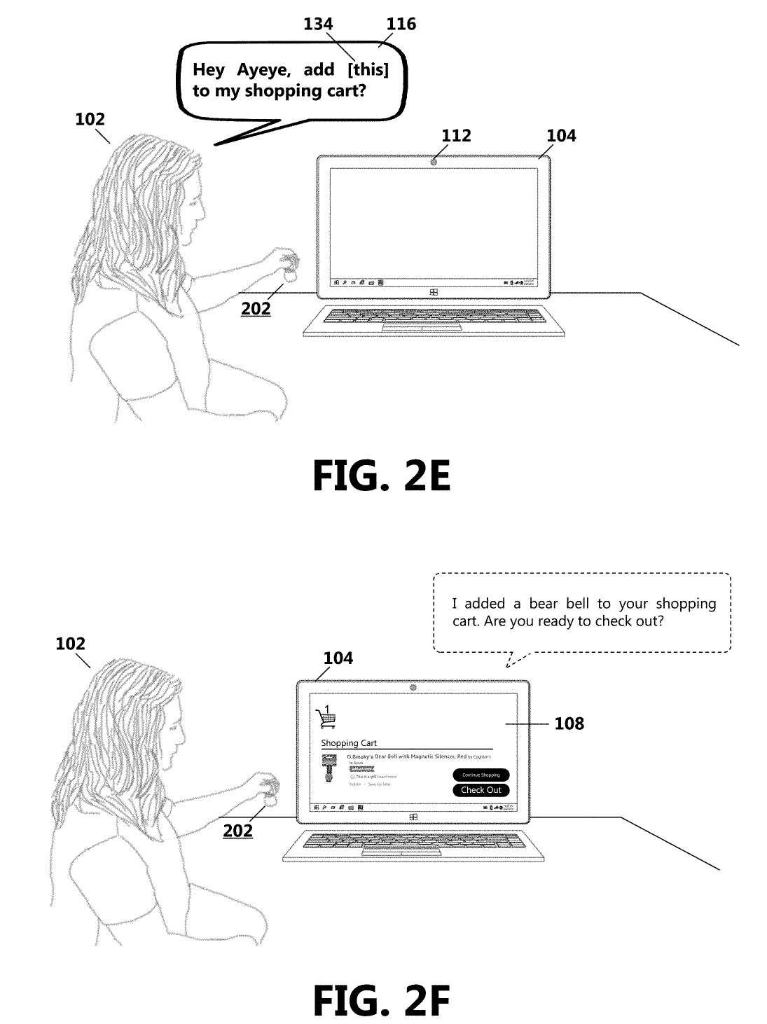

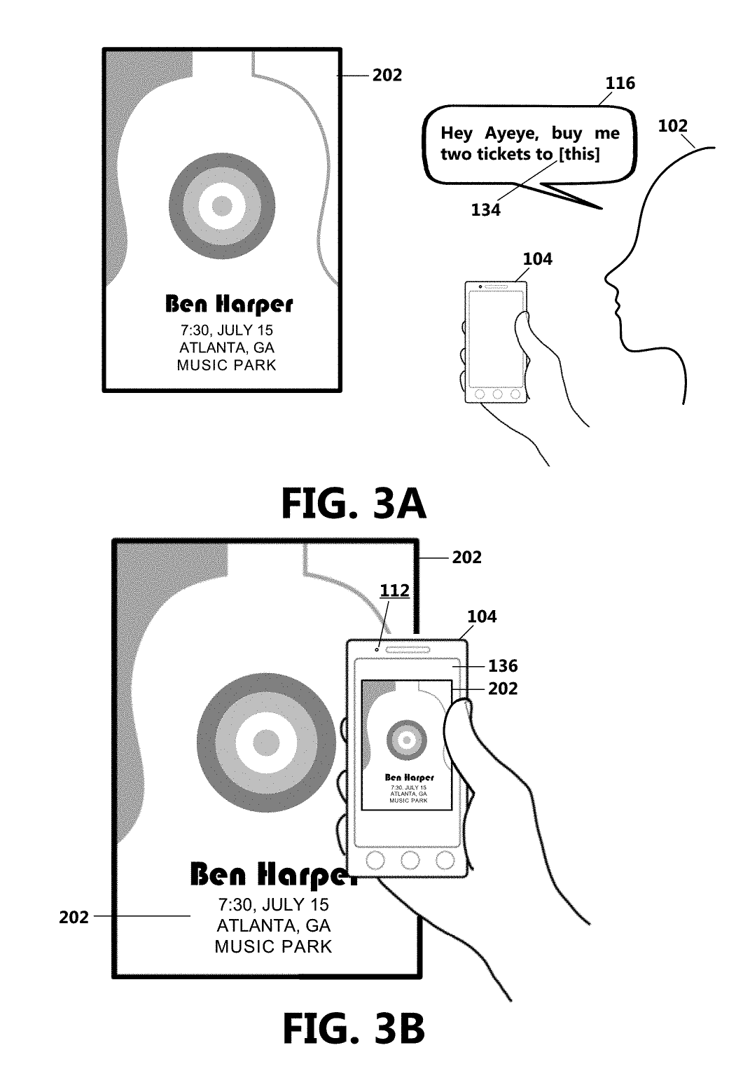

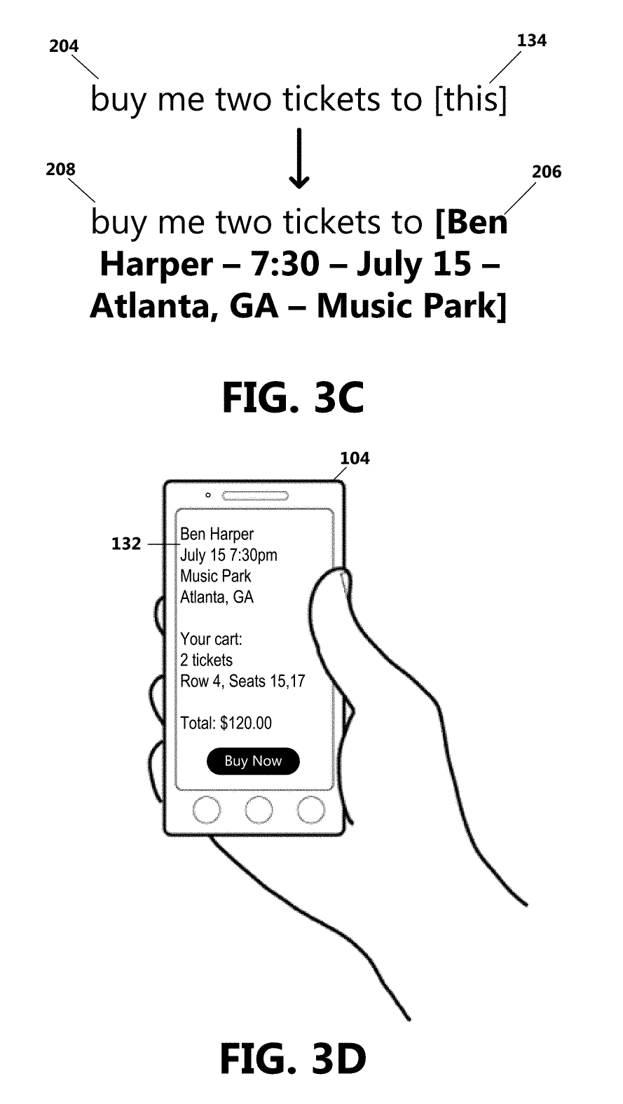

Having described example operating environments 100,150 and components of the image integrated query system 105, FIGS. 2A-2F and FIGS. 3A-3D show illustrative scenarios where a user provides a trigger in an utterance, and an image is automatically captured and processed as contextual information in query understanding and task completion. With reference now to FIG. 2A, a user 102 is using a client computing device 104 embodied as a laptop computer, and speaks the utterance 116 “Hey Ayeye, what is this” while holding an object of interest 202 in front of a camera 112 integrated in the client computing device 104. For example, the digital assistant 110 is activated responsive to the example digital assistant trigger phrase “hey Ayeye,” and the object of interest 202 is a bell. The digital assistant 110 receives the spoken utterance 116 and detects a trigger 134 “this” in the utterance.

With reference now to FIG. 2B, responsive to detecting the trigger 134, the digital assistant 110 activates the camera 112. The camera 112 then captures an image 136 of the object of interest 202, and passes the utterance 116, the captured image 136, and context information 138 to the image integrated query system 105. In some examples and as illustrated, the captured image 136 is displayed to the user 102.

With reference now to FIG. 2C, the speech recognition engine 118 performs speech recognition on the received utterance 116, and converts the spoken audio to text 204. Further, the image processor 120 performs image and text recognition on the captured image 136, and identifies objects 202 and text in the image. For example, the identified object 206 in the image 136 is a bear bell. In some examples, the image recognizer 122 is further operative to identify that a person is holding an object of interest 202 or is pointing to an object of interest, which can be using as a signal to increase confidence that the object of interest 202 is within the camera frame. The converted text 204 of the utterance 116 is combined with the identified object 206, and the semantic intent 208 of the utterance is understood and passed to the digital assistant 110. For example, it can be understood that the user's intent is to perform a search query on a bear bell.

With reference now to FIG. 2D, the digital assistant 110 queries a search engine 140 for information about bear bells, and provides a response 132 to the query to the user 102. In some examples, the requested information is displayed in a GUI displayed on the screen of the client computing device 104. In other examples, the requested information is provided to the user 102 as audio played through a speaker 114.

With reference now to FIG. 2E, the user 102 is shown providing another utterance 116. The utterance 116 can be a standalone utterance, or can be a follow-up to a previous utterance. For example, the user speaks, “hey Ayeye, add this to my shopping cart” while holding the object of interest 202 in front of the camera 112. The digital assistant 110 is activated and receives the utterance 116. The digital assistant then identifies the trigger 134 “this”, and turns on the camera 112. The camera 112 captures an image 136 of the object of interest 202, which is sent to the image integrated query system 105 in addition to the utterance 116 and context information 138. In some examples, the utterance 116, the captured image 136, and the context information 138 are sent in a single transaction. In other examples, the utterance 116, the captured image 136, and the context information 138 are sent in separate transactions. In this example, the image integrated query system 105 performs speech and image recognition on the received information, which interprets the content of the image 136 as part of the command indicated in the spoken utterance 116, and provides the understood semantic intent of the utterance to the digital assistant 110.

With reference now to FIG. 2F, the digital assistant 110 launches an application 108 associated with the semantic intent of the utterance 116 and the identified object 206, and performs a task on behalf of the user 102. For example, the digital assistant 110 launches an online retailer application 108, searches for the identified object 206, and adds the identified object to a shopping cart as specified in the utterance 116.

With reference now to FIG. 3A, a user 102 is using a client computing device 104 embodied as a mobile phone, and speaks the example utterance 116 “Hey Ayeye, buy me two tickets to this” while holding the mobile phone up to an object of interest 202. For example, the digital assistant 110 is activated responsive to the example digital assistant trigger phrase “hey Ayeye.” The object of interest 202 in the example is a concert poster. The digital assistant 110 receives the spoken utterance 116 and detects a trigger 134 “this” in the utterance.

With reference now to FIG. 3B, responsive to detecting the trigger 134, the digital assistant 110 activates the camera 112. The camera 112 then captures an image 136 of the object of interest 202, and passes the utterance 116, the captured image 136, and context information 138 to the image integrated query system 105. In some examples and as illustrated, the captured image 136 is displayed to the user 102.

With reference now to FIG. 3C, the speech recognition engine 118 performs speech recognition on the received utterance 116, and converts the spoken audio to text 204. Further, the image processor 120 performs image and text recognition on the captured image 136, and identifies objects 202 and text 302 in the image. For example, the identified object 206 in the image 136 is a music concert poster including text 302 that includes information about the music concert, such as the musician, the date of the concert, and the location of the concert. The converted text 204 of the utterance 116 is combined with the identified object 206 and recognized text 302, and the semantic intent 208 of the utterance is understood and passed to the digital assistant 110. For example, it can be understood that the user's intent is to purchase two tickets to the concert advertised by the music concert poster.

With reference now to FIG. 3D, the digital assistant 110 queries a search engine 140 for a website for purchasing the tickets or launches an application 108 that enables the user 102 to buy tickets to the concert for completing the task specified by the utterance 116 in combination with the image data. In some aspects, the response 132 is displayed in the GUI of the client device 104 for the user 102 to verify the query or take next steps based on the query, such as submitting a command based on the response 132.

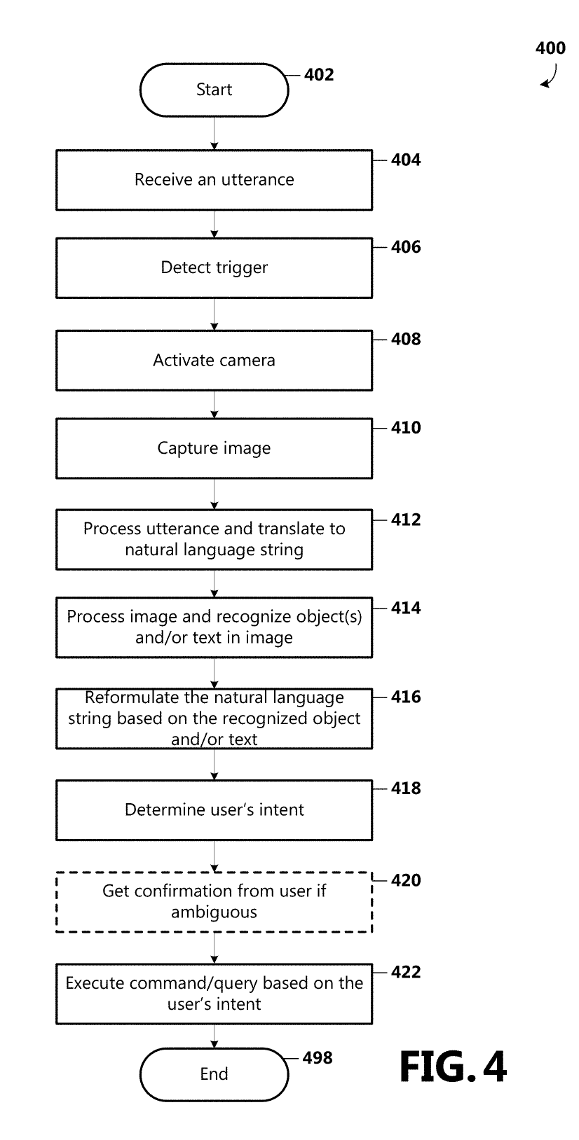

FIG. 4 is a flow chart showing general stages involved in an example method 400 for providing query understanding using integrated image capture and recognition. With reference now to FIG. 4, the method 400 begins at START OPERATION 402, and proceeds to OPERATION 404, where a user 102 provides a spoken utterance 116 (e.g., a search query or command), which is received by a microphone 106 integrated in or communicatively attached to a client computing device 104. In some examples, the utterance 116 includes a trigger word or phrase that operates to activate the digital assistant 110.

The method 400 continues to OPERATION 406, where the digital assistant 110 is activated and receives an indication of a trigger 134 in the utterance 116. For example, the trigger 134 can be a literal term or phrase associated with the image capture command or can be a term or phrase determined to be associated with the image capture command. In some examples, the utterance 116 is communicated with the intent integrated query system 105 in real time or near real time.

At OPERATION 408, responsive to receiving the indication of the trigger 134, the camera 112 integrated in or communicatively attached to the client computing device 104 is activated. The method 400 proceeds to OPERATION 410, where an image 136 is captured and sent to the intent integrated query system 105. In some examples, context information 138, such as time/date, the user's location, language, schedule, applications 108 installed on the client computing device 104, the user's preferences, the user's behaviors (in which such behaviors are monitored/tracked with notice to the user and the user's consent), stored contacts (including, in some cases, links to a local user's or remote user's social graph such as those maintained by external social networking services), call history, messaging history, browsing history, device type, device capabilities, and the like, is also communicated with the intent integrated query system 105.

At OPERATION 412, the speech recognition engine 118 performs speech recognition on the received utterance 116 for converting the spoken audio to text, and passes the converted text to the intent system 126. At OPERATION 414, the image processor 120 analyzes the captured image 134, and identifies objects, places, people, writing, or actions in the image. The image processor 120 then passes the identified objects 206 and/or text 302 to the intent system 126.

The method 400 proceeds to OPERATION 416, where the intent system 126 combines the identified objects 206 and/or text 302 from the image 134 into the converted text, and using natural language processing (NLP) for determining the user's intent at OPERATION 418. In some examples, one or more pieces of context information 138 are used to help determine the user's intent. Confidence scores are calculated based on a probability of a NLP output being correct, and a highest ranking NLP output is selected as the semantic search query or command understood for the utterance 116 combined with the image data.

In some examples, the method 400 proceeds to OPERATION 420, where the user 102 is prompted for confirmation. In some examples, the user 102 is prompted for confirmation when the user intent is ambiguous. For example, confidence scores of NLP outputs generated by the intent system 126 may be low, or more than one NLP output may have similar or generally equivalent confidence scores.

The method 400 continues to OPERATION 422, where the digital assistant 110 executes the command or search query based on the determined user intent. For example, the digital assistant 110 can interact with the user 102 (e.g., through the natural language UI and other graphical UIs); perform tasks (e.g., make note of appointments in the user's calendar, send messages and emails); provide services (e.g., answer questions from the user, map directions to a destination); gather information (e.g., find information requested by the user about a book or movie, locate a nearest Italian restaurant); operate the client computing device 104 (e.g., set preferences, adjust screen brightness, turn wireless connections on and off); and perform various other functions on behalf of the user. The method 400 ends at OPERATION 498.

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 5-7 and the associated descriptions provide a discussion of a variety of operating environments in which examples are practiced. However, the devices and systems illustrated and discussed with respect to FIGS. 5-7 are for purposes of example and illustration and are not limiting of a vast number of computing device configurations that are using for practicing aspects, described herein.

FIG. 5 is a block diagram illustrating physical components (i.e., hardware) of a computing device 500 with which examples of the present disclosure are be practiced. In a basic configuration, the computing device 500 includes at least one processing unit 502 and a system memory 504. According to an aspect, depending on the configuration and type of computing device, the system memory 504 comprises, but is not limited to, volatile storage (e.g., random access memory), non-volatile storage (e.g., read-only memory), flash memory, or any combination of such memories. According to an aspect, the system memory 504 includes an operating system 505 and one or more program modules 506 suitable for running software applications 550. According to an aspect, the system memory 504 includes the digital assistant 110. According to another aspect, the system memory 504 includes one or more components of the image integrated query system 105. The operating system 505, for example, is suitable for controlling the operation of the computing device 500. Furthermore, aspects are practiced in conjunction with a graphics library, other operating systems, or any other application program, and is not limited to any particular application or system. This basic configuration is illustrated in FIG. 5 by those components within a dashed line 508. According to an aspect, the computing device 500 has additional features or functionality. For example, according to an aspect, the computing device 500 includes additional data storage devices (removable and/or non-removable) such as, for example, magnetic disks, optical disks, or tape. Such additional storage is illustrated in FIG. 5 by a removable storage device 509 and a non-removable storage device 510.

As stated above, according to an aspect, a number of program modules and data files are stored in the system memory 504. While executing on the processing unit 502, the program modules 506 (e.g., the digital assistant 110 and in some examples, one or more components of the image integrated query system 105) perform processes including, but not limited to, one or more of the stages of the method 400 illustrated in FIG. 4. According to an aspect, other program modules are used in accordance with examples and include applications such as electronic mail and contacts applications, word processing applications, spreadsheet applications, database applications, slide presentation applications, drawing or computer-aided drafting application programs, etc.

According to an aspect, aspects are practiced in an electrical circuit comprising discrete electronic elements, packaged or integrated electronic chips containing logic gates, a circuit using a microprocessor, or on a single chip containing electronic elements or microprocessors. For example, aspects are practiced via a system-on-a-chip (SOC) where each or many of the components illustrated in FIG. 5 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 500 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects are practiced within a general purpose computer or in any other circuits or systems.

According to an aspect, the computing device 500 has one or more input device(s) 512 such as a keyboard, a mouse, a pen, a sound input device, a touch input device, etc. The output device(s) 514 such as a display, speakers, a printer, etc. are also included according to an aspect. The aforementioned devices are examples and others may be used. According to an aspect, the computing device 500 includes one or more communication connections 516 allowing communications with other computing devices 518. Examples of suitable communication connections 516 include, but are not limited to, radio frequency (RF) transmitter, receiver, and/or transceiver circuitry; universal serial bus (USB), parallel, and/or serial ports.

The term computer readable media as used herein include computer storage media. Computer storage media include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (i.e., memory storage.) According to an aspect, computer storage media includes RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. According to an aspect, any such computer storage media is part of the computing device 500. Computer storage media does not include a carrier wave or other propagated data signal.

According to an aspect, communication media is embodied by computer readable instructions, data structures, program modules, or other data in a modulated data signal, such as a carrier wave or other transport mechanism, and includes any information delivery media. According to an aspect, the term “modulated data signal” describes a signal that has one or more characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

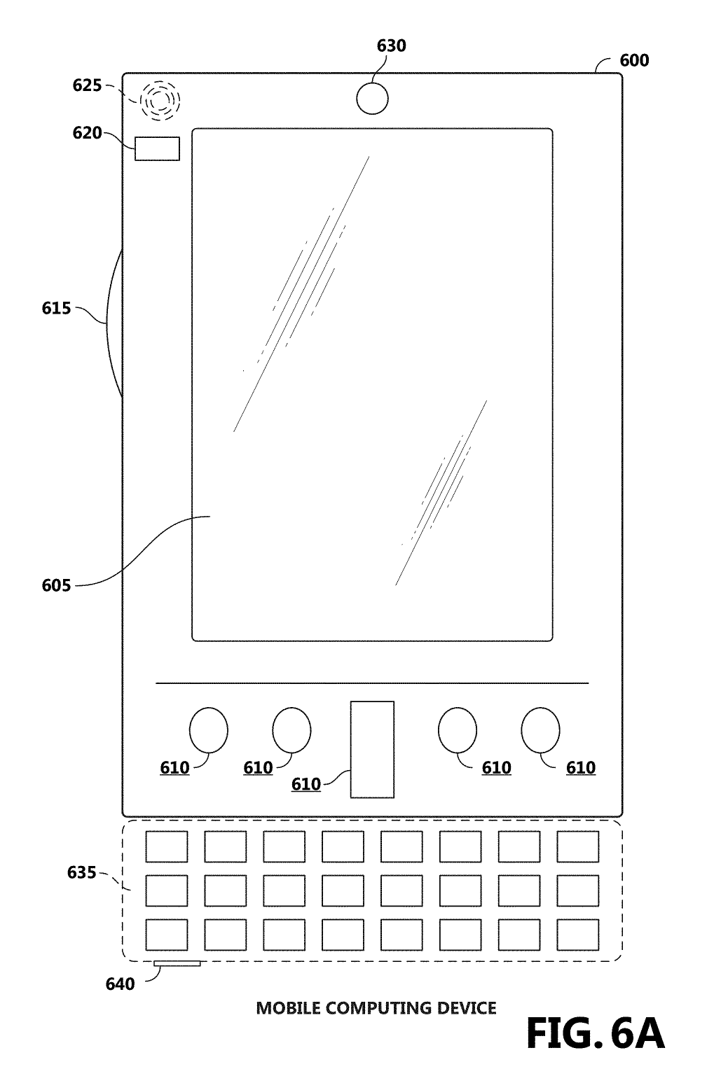

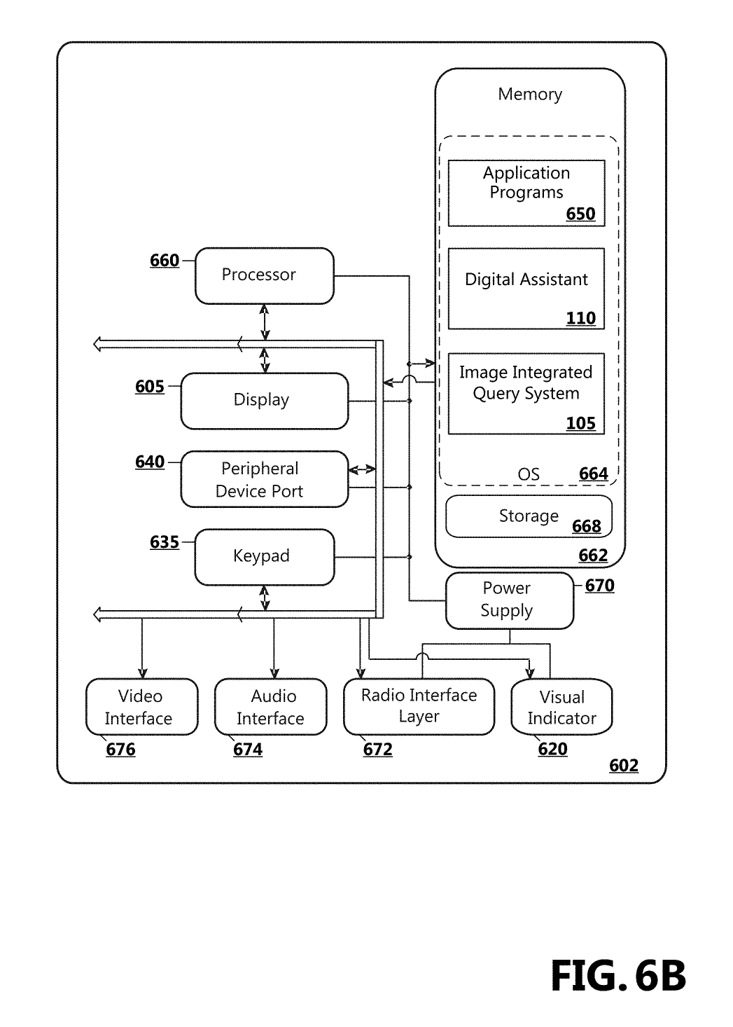

FIGS. 6A and 6B illustrate a mobile computing device 600, for example, a mobile telephone, a smart phone, a tablet, personal computer, a laptop computer, and the like, with which aspects may be practiced. With reference to FIG. 6A, an example of a mobile computing device 600 for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. According to an aspect, the display 605 of the mobile computing device 600 functions as an input device (e.g., a touch screen display). If included, an optional side input element 615 allows further user input. According to an aspect, the side input element 615 is a rotary switch, a button, or any other type of manual input element. In alternative examples, mobile computing device 600 incorporates more or less input elements. For example, the display 605 may not be a touch screen in some examples. In alternative examples, the mobile computing device 600 is a portable phone system, such as a cellular phone. According to an aspect, the mobile computing device 600 includes an optional keypad 635. According to an aspect, the optional keypad 635 is a physical keypad. According to another aspect, the optional keypad 635 is a “soft” keypad generated on the touch screen display. In various aspects, the output elements include the display 605 for showing a graphical user interface (GUI), a visual indicator 620 (e.g., a light emitting diode), and/or an audio transducer 625 (e.g., a speaker). In some examples, the mobile computing device 600 incorporates a vibration transducer for providing the user with tactile feedback. In yet another example, the mobile computing device 600 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 600 incorporates peripheral device port 640, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one example of a mobile computing device. That is, the mobile computing device 600 incorporates a system (i.e., an architecture) 602 to implement some examples. In one example, the system 602 is implemented as a “smart phone” capable of running one or more applications (e.g., browser, e-mail, calendaring, contact managers, messaging clients, games, and media clients/players). In some examples, the system 602 is integrated as a computing device, such as an integrated digital assistant (PDA) and wireless phone.

According to an aspect, one or more application programs 650 are loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. According to an aspect, the digital assistant 110 is loaded into memory 662. According to another aspect, one or more components of the image integrated query system 105 are loaded into memory 662. The system 602 also includes a non-volatile storage area 668 within the memory 662. The non-volatile storage area 668 is used to store persistent information that should not be lost if the system 602 is powered down. The application programs 650 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600.

According to an aspect, the system 602 has a power supply 670, which is implemented as one or more batteries. According to an aspect, the power supply 670 further includes an external power source, such as an AC adapter or a powered docking cradle that supplements or recharges the batteries.

According to an aspect, the system 602 includes a radio 672 that performs the function of transmitting and receiving radio frequency communications. The radio 672 facilitates wireless connectivity between the system 602 and the “outside world,” via a communications carrier or service provider. Transmissions to and from the radio 672 are conducted under control of the operating system 664. In other words, communications received by the radio 672 may be disseminated to the application programs 650 via the operating system 664, and vice versa.

According to an aspect, the visual indicator 620 is used to provide visual notifications and/or an audio interface 674 is used for producing audible notifications via the audio transducer 625. In the illustrated example, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. According to an aspect, the system 602 further includes a video interface 676 that enables an operation of an on-board camera 630 to record still images, video stream, and the like.

According to an aspect, a mobile computing device 600 implementing the system 602 has additional features or functionality. For example, the mobile computing device 600 includes additional data storage devices (removable and/or non-removable) such as, magnetic disks, optical disks, or tape. Such additional storage is illustrated in FIG. 6B by the non-volatile storage area 668.

According to an aspect, data/information generated or captured by the mobile computing device 600 and stored via the system 602 is stored locally on the mobile computing device 600, as described above. According to another aspect, the data is stored on any number of storage media that is accessible by the device via the radio 672 or via a wired connection between the mobile computing device 600 and a separate computing device associated with the mobile computing device 600, for example, a server computer in a distributed computing network, such as the Internet. As should be appreciated such data/information is accessible via the mobile computing device 600 via the radio 672 or via a distributed computing network. Similarly, according to an aspect, such data/information is readily transferred between computing devices for storage and use according to well-known data/information transfer and storage means, including electronic mail and collaborative data/information sharing systems.

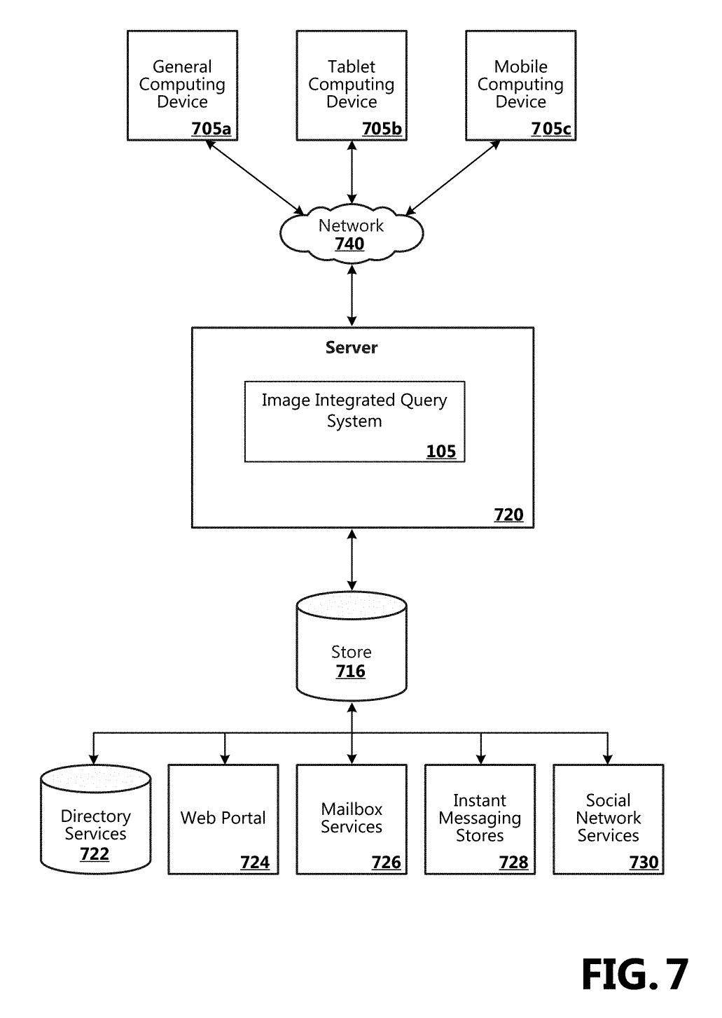

FIG. 7 illustrates one example of the architecture of a system for providing query understanding using integrated image capture and recognition, as described above. Content developed, interacted with, or edited in association with the image integrated query system 105 is enabled to be stored in different communication channels or other storage types. For example, various documents may be stored using a directory service 722, a web portal 724, a mailbox service 726, an instant messaging store 728, or a social networking site 730. The image integrated query system 105 is operative to use any of these types of systems or the like for providing query understanding using integrated image capture and recognition, as described herein. According to an aspect, a server 720 provides the image integrated query system 105 to clients 705a,b,c. As one example, the server 720 is a web server providing the image integrated query system 105 over the web. The server 720 provides the image integrated query system 105 over the web to clients 705 through a network 740. By way of example, the client computing device is implemented and embodied in a personal computer 705a, a tablet computing device 705b or a mobile computing device 705c (e.g., a smart phone), or other computing device. Any of these examples of the client computing device are operable to obtain content from the store 716.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

We claim:

1. A system for providing query understanding using integrated image capture and recognition, comprising:
a processing unit; and
a memory, including computer readable instructions, which when executed by the processing unit is operable to:
capture an utterance;
responsive to receiving an indication of a trigger in the utterance, activate a camera;
capture an image of an object of interest;
pass the utterance and the image to a processing system for converting the utterance to text and determining a user intent based in part on identification of the object of interest in the captured image; and
process a search query or complete a task based on the determined user intent.

2. The system of claim 1, wherein the trigger is a literal word or phrase associated with an image capture command.

3. The system of claim 1, wherein the trigger is a word or phrase determined to be associated with an image capture command.

4. The system of claim 1, wherein the object of interest comprises at least one of:
an object;
a place;
a person;
text; and
an action.

5. The system of claim 1, wherein the system comprises a digital assistant.

6. The system of claim 1, wherein the processing system comprises a speech recognition engine operative to perform speech recognition to convert the utterance to text.

7. The system of claim 6, wherein the processing system comprises an image recognizer operative to perform image recognition on the captured image to identify the object of interest.

8. The system of claim 7, wherein the image recognizer is further operative to identify the object of interest based on an identification on whether the object of interest is held by a user or is being pointed to by a user.

9. The system of claim 7, wherein the processing system comprises a text recognizer operative to perform text recognition on the captured image to identify and extract text.

10. The system of claim 9, wherein the processing system is further operative to combine the converted text from the utterance, the identified object of interest from the captured image, and extracted and identified text from the captured image for determining the user intent.

11. The system of claim 1, wherein the system is further operative to obtain and pass context information to the processing system for determining the user intent.

12. A method for providing query understanding using integrated image capture and recognition, comprising:
capturing an utterance;
responsive to receiving an indication of a trigger in the utterance, activating a camera;
capturing an image of an object of interest;
passing the utterance and the image to a processing system for converting the utterance to text and determining a user intent based in part on identification of the object of interest in the captured image; and
processing a search query or completing a task based on the determined user intent.

13. The method of claim 12, wherein receiving the indication of the trigger comprises detecting a literal word or phrase associated with an image capture command.

14. The method of claim 12, wherein receiving the indication of the trigger comprises detecting a word or phrase determined to be associated with an image capture command.

15. The method of claim 12, further comprising:
collecting context information related to the captured image; and
passing the context information to the processing system for determining the user intent.

16. The method of claim 12, wherein capturing the utterance comprises:
detecting a trigger word or phrase associated with activating a digital assistant; and
responsive to the detection, activating the digital assistant.

17. The method of claim 12, wherein processing the search query or completing the task based on the determined user intent comprises processing the search query or completing the task based on a highest ranked user intent according to a confidence score.

18. A computer readable storage device including computer readable instructions, which when executed by a processing unit is operable to:
capture an utterance;
responsive to receiving an indication of a trigger in the utterance, activate a camera;
capture an image of an object of interest;
perform speech recognition on the captured utterance to convert the utterance to text;
perform image recognition on the captured image to identify the object of interest;
combine the converted text from the utterance and the identified object of interest from the captured image for determining the user intent; and
process a search query or complete a task based on the determined user intent.

19. The computer readable storage device of claim 18, wherein the device is further operative to:
perform text recognition on the captured image to identify and extract text; and
combine the identified and extracted text with the converted text from the utterance and the identified object of interest from the captured image for determining the user intent.

20. The computer readable storage device of claim 18, wherein the device is further operative to:
collect context information related to the captured image; and
determine the user intent based in part on the context information.
